(19) United States
(12) Patent Application Publication
(10) Pub. No.: US 2011/0246244 A1
(43) Pub. Date: Oct. 6, 2011

(54) COMPUTER NETWORK FOR GENERATING PROPOSED INSURANCE CLAIM SETTLEMENTS AND SUBMITTING THEM TO INSURANCE CARRIERS

(75) Inventor: Christopher J. O'Rourke, Westlake Village, CA (US)

(73) Assignee: Farmers Insurance Group of Companies, Los Angeles, CA (US)

(21) Appl. No.: 13/078,169

(22) Filed: Apr. 1, 2011

Related U.S. Application Data
(60) Provisional application No. 61/321,415, filed on Apr. 6, 2010.

(51) Int. Cl. G06Q 40/00

(52) U.S. Cl. 705/4

(57) ABSTRACT

A computer network for generating a proposed insurance claim settlement and submitting it to an insurance carrier, including: (a) a computer system that receives insurance injury information from an operator; (b) a computer system that receives accident information from the operator; (c) a computerized injury evaluation system that then computes: (i) a proposed claim settlement based upon the injury information and the accident information, and (ii) a likelihood of claim settlement based upon the identity of a selected insurance carrier; (d) a computer system that presents the proposed claim settlement and the likelihood of claim settlement to the operator; and (e) a computer system that sends the proposed claim settlement from the computerized injury evaluation system to the selected insurance carrier after receiving an approval from the operator.

### RELATED APPLICATION

The present invention claims priority to U.S. Provisional Patent Application Ser. No. 61/321,415, filed Apr. 6, 2010, entitled “Claim Loss Evaluation Assistance and Review”, incorporated herein by reference in it's entirety for all purposes.

### TECHNICAL FIELD

The present invention is directed to a computer network that automatically generates proposed insurance claim settlements for claimants and also act as submission management centers between the claimants and their selected insurance carriers.

### BACKGROUND OF THE INVENTION

Following a typical injury accident (such as a motor vehicle accident), a claimant contacts their insurance carrier. The insurance carrier then assists the claimant in preparing a claim. This is typically a back-and-forth process with the insurance carrier requesting that the claimant furnish evidentiary proofs such as injury records, vehicle damage estimates, statements of earnings loss, etc. to support their claim. Thereafter, the insurance carrier reviews the claim and eventually determines the amount that it will offer to pay to the claimant.

This existing system has many disadvantages, the biggest one being its complexity and the amount of time required to achieve claim settlement. Moreover, the insurance carriers also spend a lot of time handing claims that are quite similar to one another. Individual claimants are typically quite unfamiliar with the process. Therefore, the insurance carriers must spend time educating each one of them as to what is required. A lot of time is spent in repetitive activities (while assisting claimants make their own individual claims). In addition, many of these claims are actually similar and end of being settled for similar amounts of money. These problems especially occur in the case of common accidents like cars being involved in rear-end collisions.

To date, however, there has been no easy way for insurance carriers to avoid the significant amounts of repetitive work to achieve appropriate claim settlements for large numbers of similarly situated individual accident victims. It would instead be desirable to have a system that allows for the submission of similar low complexity claims in a more automated way. It would be even more desirable if such claims could be prepared and submitted by the claimant directly to the insurance carrier in an automated, easy to use on-line fashion.

Secondly, from the point of view of the claimant, preparing a claim submission is a process which has traditionally required considerable amounts of energy to prepare documentation about an area in which they typically have little familiarity. In addition, claimants simply prepare their submissions and then wait a period of time to hear back from their insurance carriers as to the amount of settlement that their insurance carrier will offer. This waiting period can be difficult for the claimants. Quite often, the typically claimant really has no idea as to the financial settlement they will receive. In addition, there is often no way for them to know how their insurance carrier's settlement offer compares to that of other insurance carriers.

It would instead be desirable to provide a system where a claimant can be “walked through” a claims submission process in a quick, easy to use, format. It would also be desirable for such a system to immediately give the claimant a proposed settlement (after the claimant has submitted all the necessary supporting documentation). It would be ideal if the claimant could also have some idea as to the likelihood whether their insurance carrier will indeed accept the proposed settlement. The present invention, provides these advantages, and as described below, overcomes all of the above discussed drawbacks to current systems.

### SUMMARY OF THE INVENTION

The present invention allows a claimant to submit their own insurance claim easily to their selected insurance carrier through a secure computer network. The present invention provides a computerized web-based system through which an accident victim can generate, review and then submit their own proposed insurance claim to their selected insurance carrier. In the examples herein, the present invention is shown to be ideally suited for auto insurance claims with soft tissue injuries, but it is to be understood that the present invention is not so limited. Rather, it could also be used for generating and submitting other types of insurance claims as well.

Claimants input basic facts about the accident and about their insurance coverage into the present computer network. Basic facts that are submitted by the operator may include the claimant's age, the accident type, the impact location, the extent of property damage, ambulance bills, cost of initial emergency treatment, pain symptoms, and pre-accident symptoms. The present computer network then provides the claimant with the opportunity to submit proofs necessary to support their claim. As part of the present computerized system, the insurance carriers then have an opportunity to check the facts of the loss with their insured, confirm coverage and run a fraud check. In addition, claimants can be advised when their medical bills or loss of earnings claims are more than would normally be expected.

There are many advantages to the present invention. Such advantages may include: (1) ease of use by both claimants and insurance carriers, (2) rapid preparation of proposed insurance claim settlements for review by the claimants, (3) claimants having the ability to see how likely it is that their claim will actually be accepted by their insurance carrier (before even formally submitting the claim); and (4) insurance carriers having the ability to perform fraud checks and to rapidly alert claimants if their claims fall outside of normal expense parameters.

In one embodiment, the present invention provides a computer network for generating a proposed insurance claim settlement and submitting the proposed insurance claim settlement to an insurance carrier, comprising: (a) a computer system that receives injury information from an operator through a web-based interface; (b) a computer system that receives accident information from the operator through a web-based interface; (c) a computerized injury evaluation system that receives the injury information and the accident information and then computes: (i) a proposed claim settlement amount based upon the injury information and the accident information, and (ii) a likelihood of claim settlement for the proposed amount based upon the identity of a selected insurance carrier; (d) a computer system that presents the proposed claim settlement amount and the likelihood of claim settlement statement to the operator through a web-based interface; and (e) a computer system that sends a demand for the proposed claim settlement amount from the computerized injury evaluation system to the selected insurance carrier after receiving an approval from the operator.

In another embodiment, the present invention provides a method for generating a proposed insurance claim settlement and submitting the proposed insurance claim settlement to an insurance carrier, comprising: (a) a remote operator sending injury information through a web-based interface to a central computerized injury evaluation system; (b) the remote operator sending accident information through a web-based interface to the central computerized injury evaluation system; (c) the remote operator selecting an insurance carrier through the web-based interface; (d) the central computerized injury evaluation system computing: (i) a proposed claim settlement based upon the injury information and the accident information, and (ii) a likelihood of claim settlement based upon the identity of the selected insurance carrier; (e) the central computerized injury evaluation system presenting the proposed claim settlement amount and the likelihood of claim settlement to the operator; and (f) the remote operator authorizing the central computerized injury evaluation system to submit the proposed claim settlement amount to the selected insurance carrier.

### BRIEF DESCRIPTION OF THE DRAWINGS

FIG. 1A is a schematic illustration of the physical components of the present invention.

FIG. 1B is schematic corresponding to FIG. 1A, but showing further details and the flow of information between a single operator/claimant, the central computer system and a single insurance carrier.

FIG. 2 is a screenshot of the system sign in screen.

FIG. 3 is a screenshot of the accident statement input screen.

FIG. 4 is a screenshot of an exemplary medical bill.

FIG. 5 is a screenshot of a screen for adding medical provider information.

FIG. 6 is a screenshot of a screen for adding employer information.

FIG. 7 is a screenshot of a supporting documents input screen.

FIG. 8 is a screenshot of a legal notices screen.

FIG. 9 is a screenshot of a claim summary and submission screen.

### DETAILED DESCRIPTION OF THE DRAWINGS

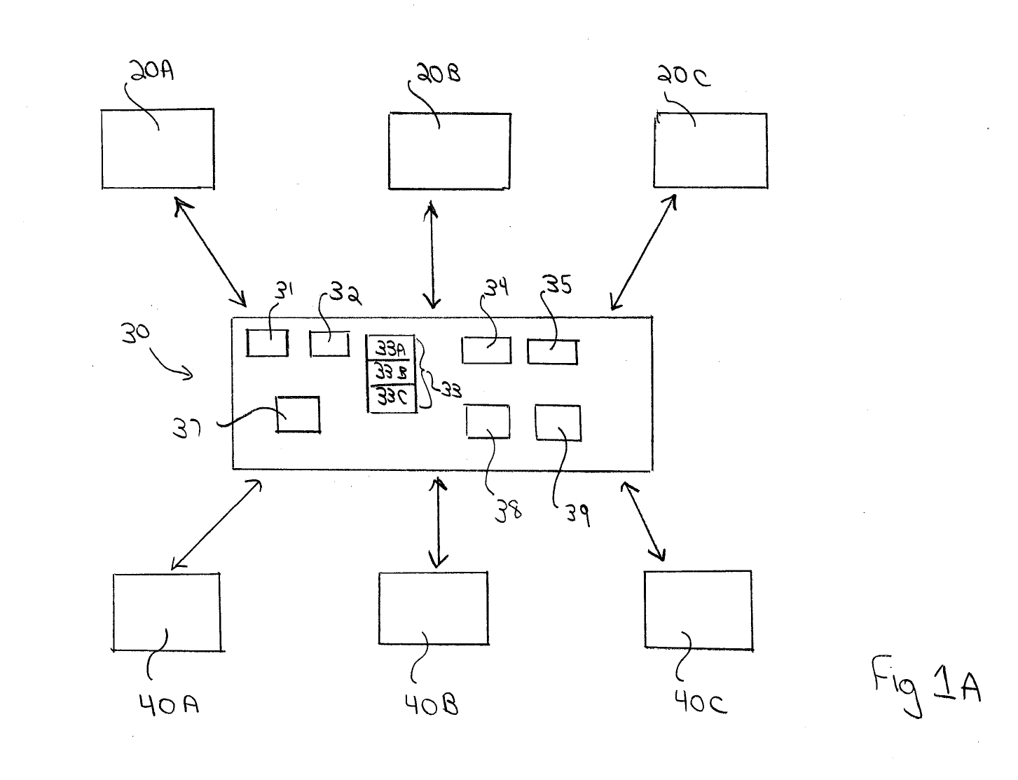

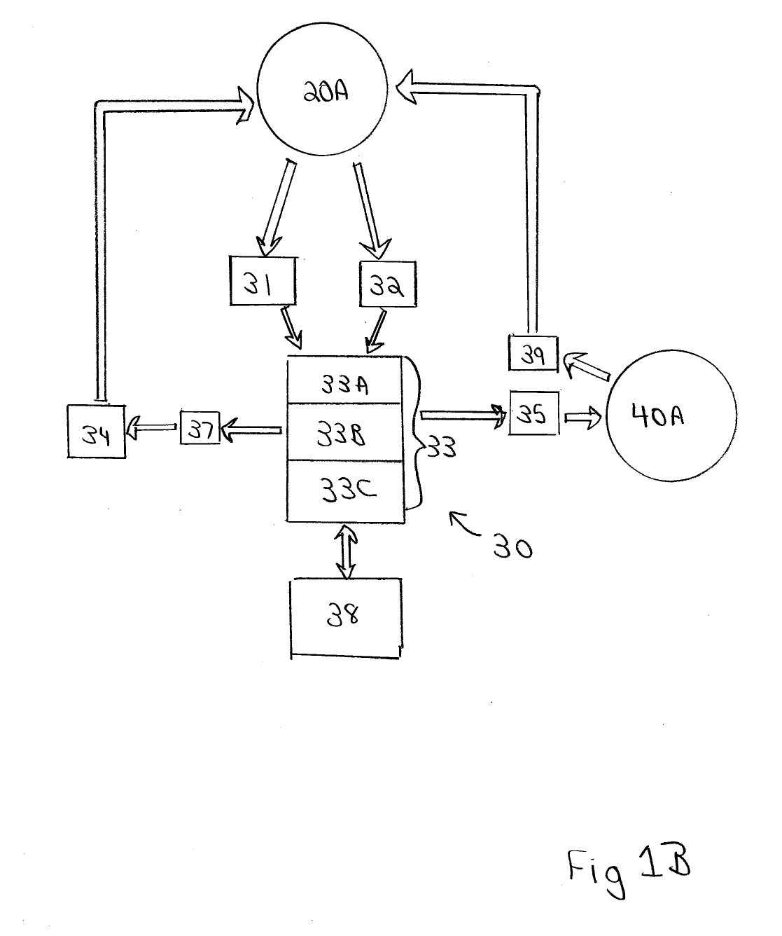

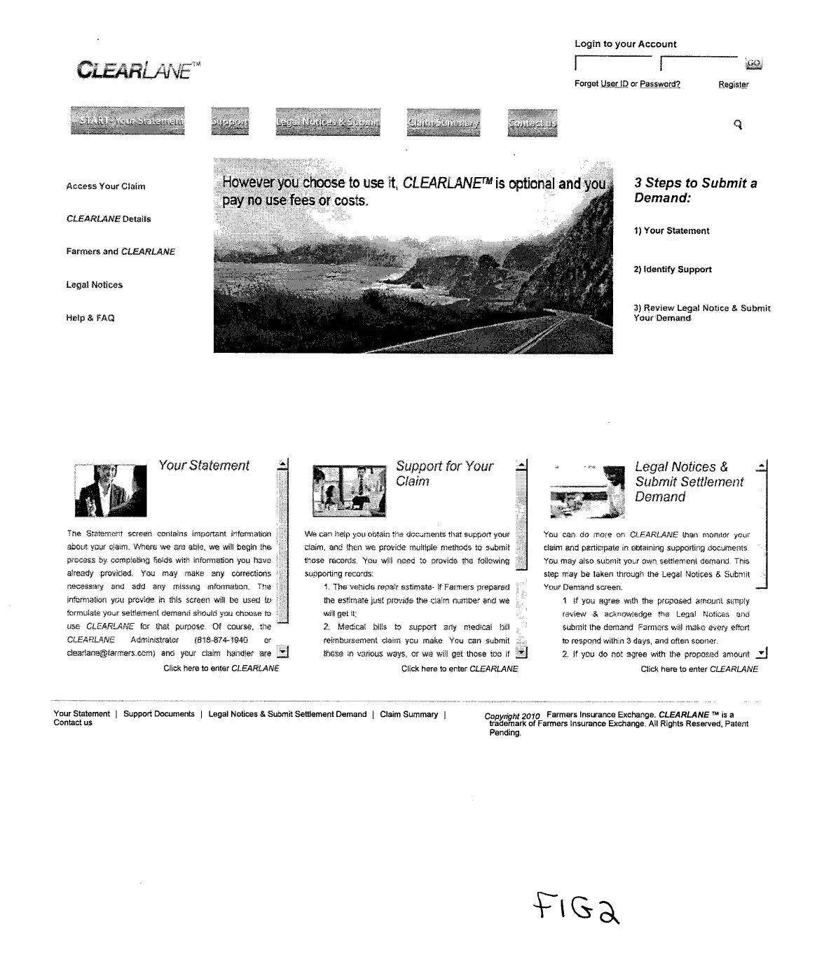

The present invention provides a computer network through which individual claimants are assisted in preparing and submitting insurance claims to their insurance carrier. As illustrated in FIG. 1A, this network 10 comprises a plurality of different claimants 20A, 20B and 20C positioned at various remote locations (for example, in their own homes), a computer system 30 located at a central facility and a plurality of insurance carriers 40A, 40B and 40C (also located in various remote locations). FIG. 1B show further details and the flow of information between a single operator/claimant 20A, central computer system 30 and insurance carrier 40A.

Computer system 30 represents the heart of the present invention. Claimants 20 are also referred to as “operators” in the specification and claims herein. It is to be understood that the present invention can be used both by claimants who were personally injured and who are generating and submitting their own proposed insurance settlements, but also by persons generating and submitting insurance claims on behalf of claimants who are personally injured. Thus, the term “operator” as used herein refers to any person (or computer system) preparing and submitting an insurance claim on behalf of the injured person.

Claimant/operators 20 and insurance carriers 40 each communicate with computer system 30 through a networked web-based interface. Computer system 30 comprises: (a) a computer system 31 that receives injury information from operators 20 through a web-based interface; (b) a computer system 32 that receives accident information from operators 20 through a web-based interface; (c) a computerized injury evaluation system 33 that receives the injury and accident information and then computes: (i) a proposed claim settlement amount based upon the injury information and the accident information, and (ii) a likelihood of claim settlement based upon the identity of a selected insurance carrier; (d) a computer system 34 that presents the proposed claim settlement amount and the likelihood of claim settlement to operators 20 through a web-based interface; and finally (e) a computer system 35 that sends the proposed claim settlement amount from the computerized injury evaluation system to the selected insurance carrier after receiving an approval from the operator.

In addition, computerized injury evaluation system 33 preferably comprises: a computer sub-system 33A that determines a financial amount that corresponds to lost earnings; a computer sub-system 33B that determines a financial amount that corresponds to payment of medical bills; and a computer sub-system 33C that determines a financial amount that corresponds to pain and suffering damages. In operation, the financial amount that corresponds to pain and suffering damages (as computed by computer sub-system 33C) may be determined as a financial range. In operation, computerized injury evaluation system 33 adds together the three financial amounts calculated by computer sub-systems 33A, 33B and 33C, and then presents the total as the proposed claim settlement to operator 20. In various embodiments, computer sub-systems 33A, 33B and 33C can either be dedicated computers, dedicated computer processors, or even dedicated software modules that are linked together.

The computer sub-system 33C preferably computes the proposed claim settlement on the basis of: (i) the age of the person injured in the accident; and (ii) the similarity of the accident to other accidents. It is to be understood, however, that the present invention is not so limited and that alternative computational systems and methods can be used, all depending upon the type of insurance claim that is being processed.

In various optional aspects, the similarity of the accident to other accidents may be determined by comparing the received accident information to accident information pre-stored in database 38. The accident information pre-stored in database 38 is preferably information corresponding to a plurality of different accidents that also occurred in the local vicinity of the accident submitted by the operator. In addition, or alternatively, the accident information pre-stored in database 38 can be information corresponding to data compiled by focus groups in the local vicinity of the accident submitted by the operator.

Once computer system 30 has generated the proposed claim settlement, and presented it to the operator for his/her review, operator 20 can then submit the proposed claim settlement directly to a selected insurance carrier. For example, operator 20A may instruct computer system 30 to send the proposed insurance claim settlement from computer system 30 to insurance carrier 40A. A unique optional aspect of the present invention is that operator 20 is able to view a statement showing the percentage of time that a selected insurance carrier has accepted the proposed claims settlement generated by computer system 30 in the past. Thus, operator 20A may see that insurance carrier 40A approves 25% of the proposed insurance claim settlements generated by system 30. In such a case, operator 20A may decide not to submit their claim to that carrier. This unique advantage does not exist in other prior art systems.

Next, the selected insurance carrier 40A will receive the submitted proposed claim settlement from computer system 30. Insurance carrier 40A will then review the proposed claim settlement and either decide to: (i) approve it for payment, or (ii) present a counter offer to the claimant. Thus, computer system 30 further comprises a computer system 39 that sends either: (i) a check and a release; or (ii) a counter offer, from insurance carrier 40A to operator 20A after receiving an approval from selected insurance carrier 40A.

As can be appreciated, computer network 10 provides a system that simultaneously receives insurance injury and accident information from a plurality of different operators 20A, 20B and 20C, and computes individual proposed claim settlements and likelihood of claim settlement proposals for each of those plurality of different operators. This unique advantage also does not exist in other prior art systems.

Most preferably, computerized injury evaluation system 33 proposes pain and suffering values based on focus group opinions for people in similar age groups involved in accidents with similar impact.

In further optional embodiments, computerized injury evaluation system 33 further comprises a validation system 37 that flags treatment duration information that is received from operator 20 when the information is outside of pre-determined range boundaries. For example, the present invention could analyze the data submitted by claimants 20 by comparing this data to data stored on medical duration tables and then alert the claimant if the duration of treatment and/or lost earnings is longer than expected for similar injuries. For example, validation system 37 could be pre-set to compare the current submitted per visit medical expenses, and flag or reject those that are above the 80^{th} percentile. Other validation settings or systems are also contemplated, all keeping within the scope of the present invention.

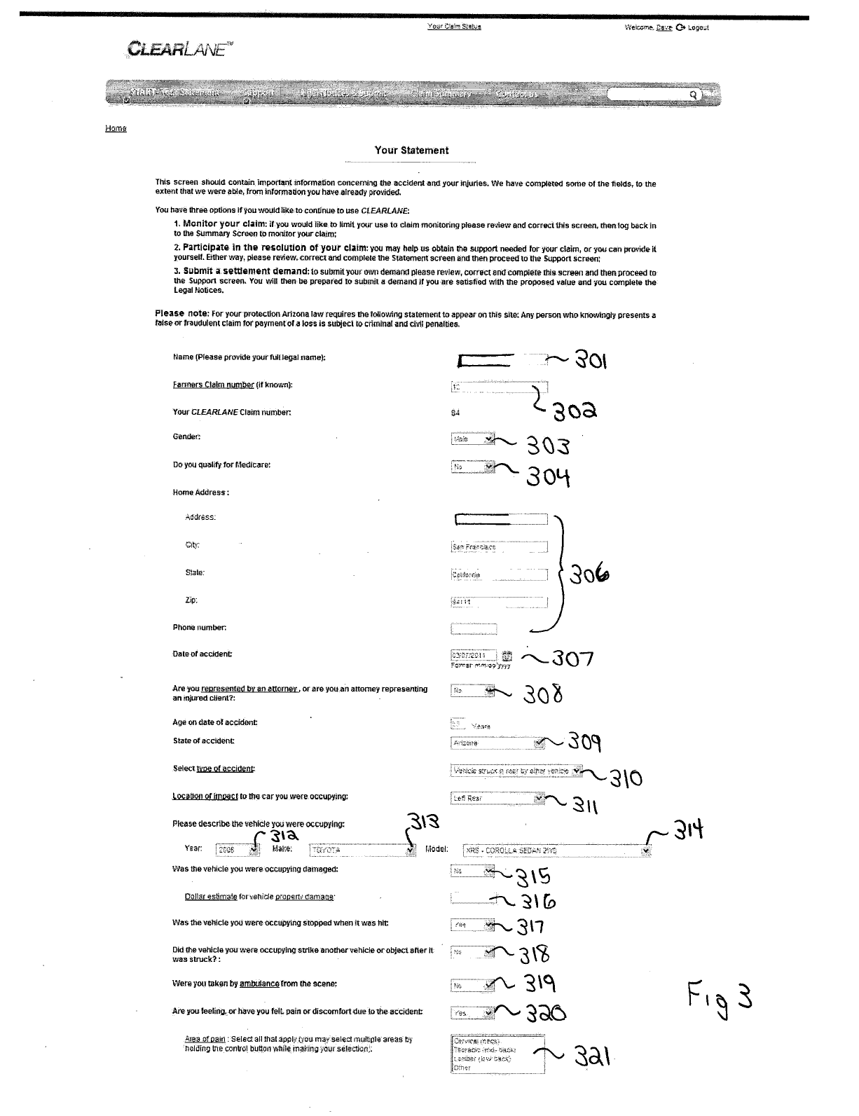

FIGS. 2 to 9 are sequential screenshots as viewed by an operator 20 when using the present invention, as will be explained. It is to be understood that these screenshots are merely exemplary and that the present invention encompasses any wed screen designs that carry out the present invention.

First, in FIG. 2, each operator 20 is presented with the system sign in screen. This screen give a brief introduction to how the present computer system operates.

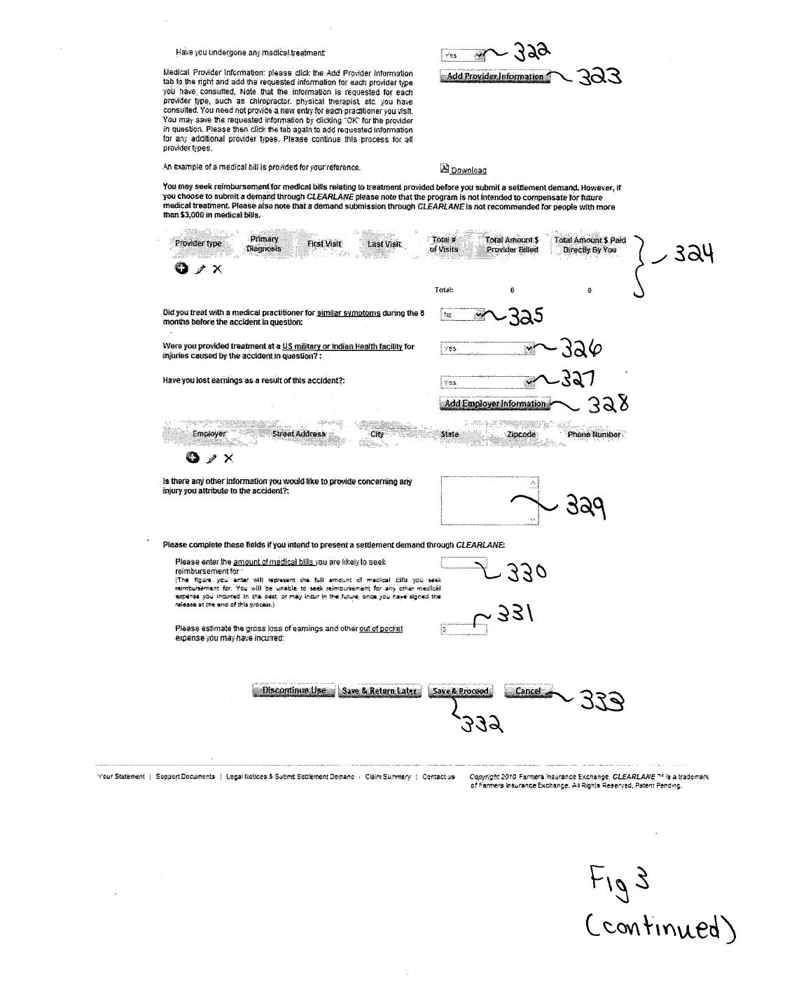

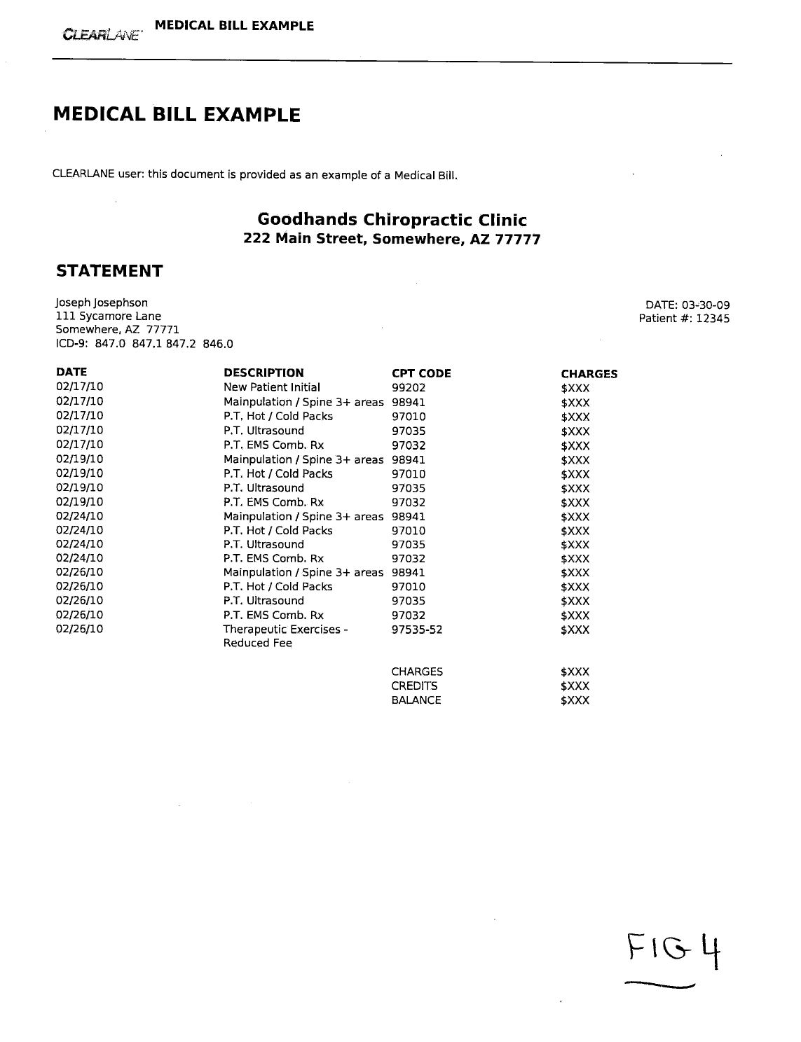

Next, after logging in, the operator views the accident statement input screen as seen in FIG. 3. The operator is again presented with instructions as to how to operate and navigate through the present invention. At 301, the operator enters his/her name. At 302, the operator enters their claim number (if known). At 303, the operator selects their gender. At 304, the operator is asked whether or not they qualify for Medicare. At fields 306, the operator fills in their contact information. At 307, the operator enters the date of the accident. At 308, the operator is asked whether or not they are represented by an attorney. In optional embodiments, this screen may also have a link to a list of qualified participating local attorneys. At 309, the operator is asked to select in which state the accident occurred. At 310, the operator is asked to select the type of accident that occurred. In this exemplary embodiment (dealing only with motor vehicle collisions), the operator selects between a dropdown menu of choices including options like “vehicle struck in rear by other vehicle”, etc. In cases where the present invention is used to generate other types of insurance claims, then other accident types could be selected. At 311, the operator selects the location of impact on the car, selecting between a dropdown menu of choices including options like “left rear”, etc. At 312 the operator enters the year of the car through a dropdown menu. At 313, the operator enters the make of the car through another dropdown menu. At 314, the operator then enters the model of the car through yet another dropdown menu. At 315, the operator is asked whether their vehicle was damaged, and at 316, they are asked to provide a dollar estimate of the damage. Preferably, this amount may be entered as free text or through a dropdown menu. Most preferably, this amount could be entered in increments of $100, but it is to be understood that the present invention is not so limited. At 317, the operator is asked whether their vehicle was stopped when it was hit. Lastly, at 318, the operator is asked whether their vehicle hit another vehicle.

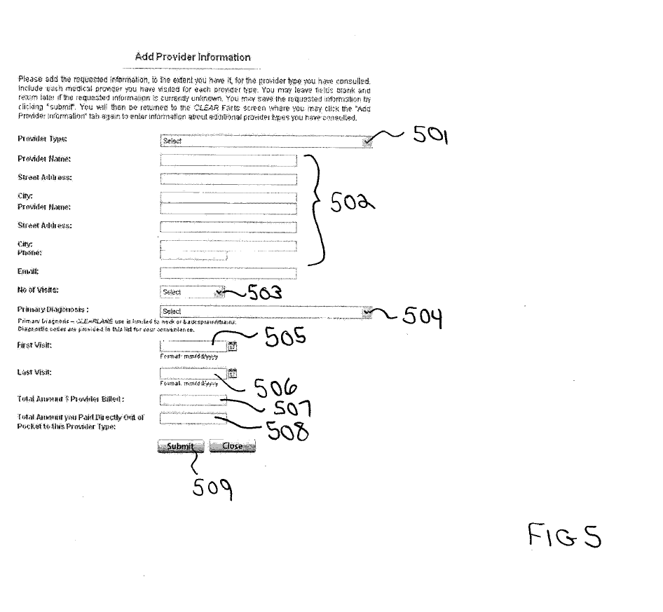

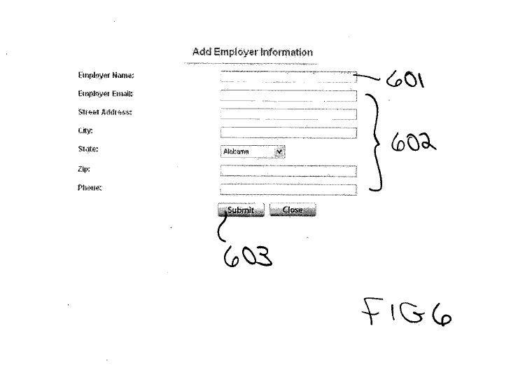

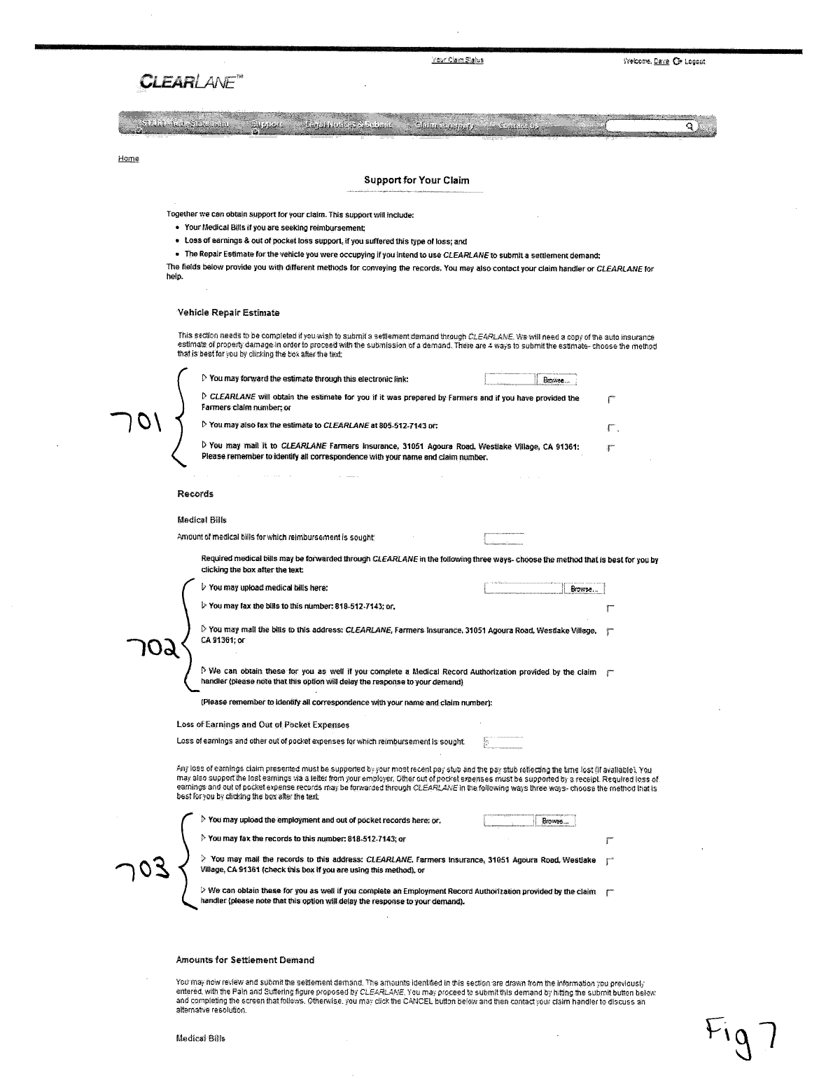

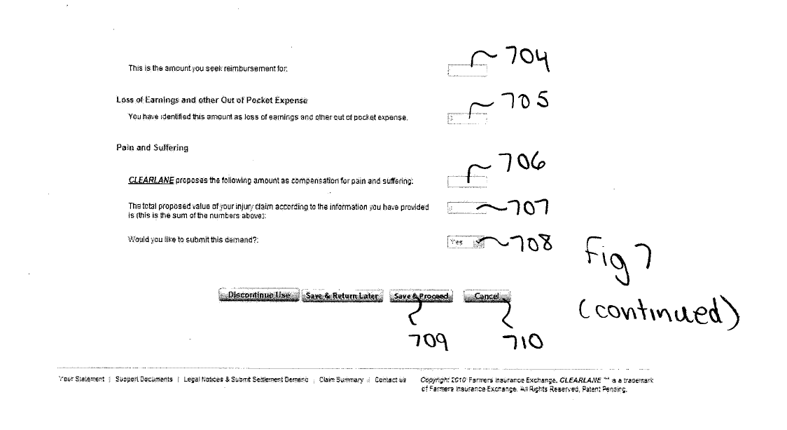

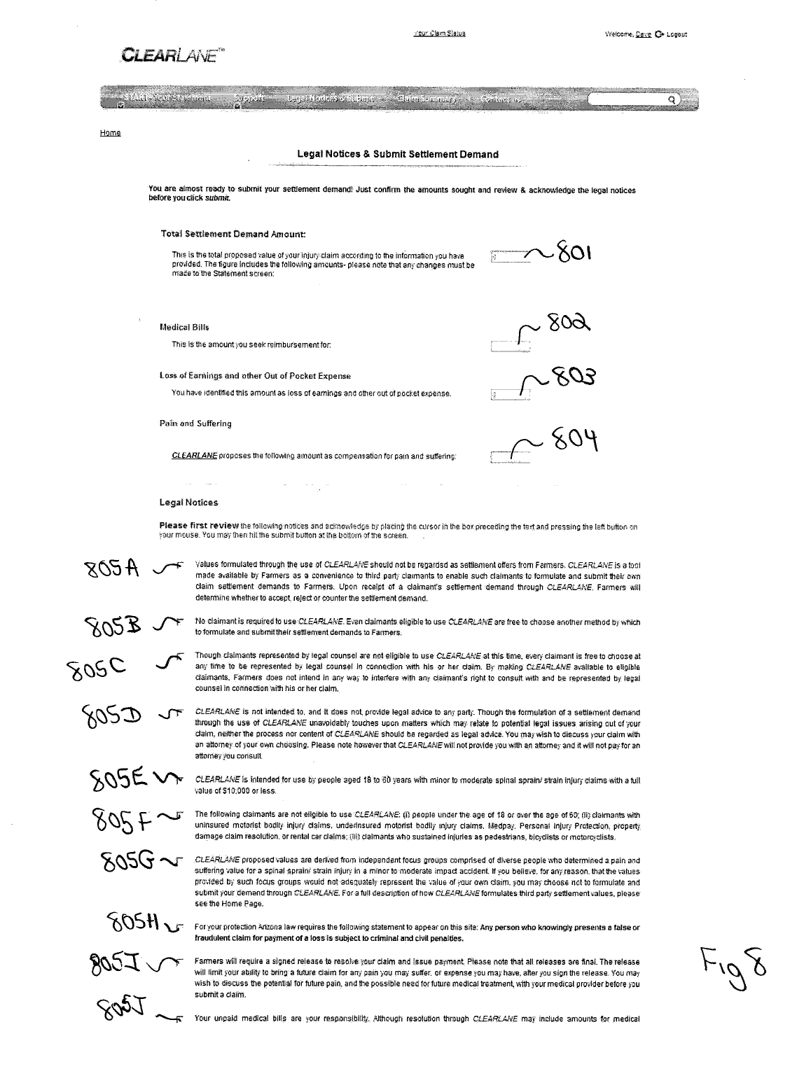

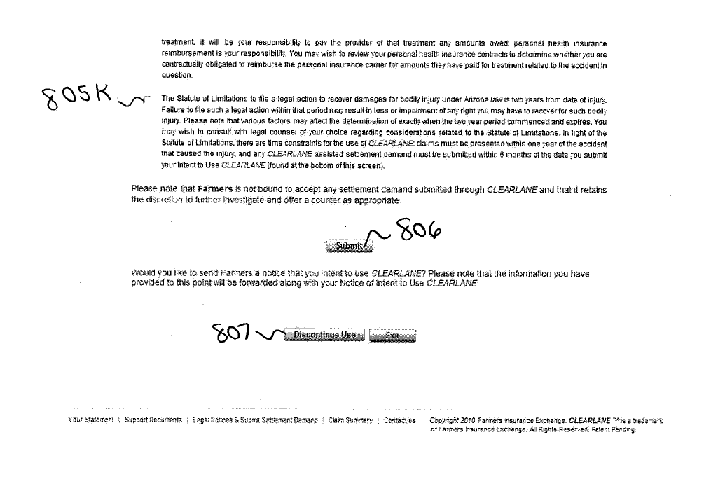

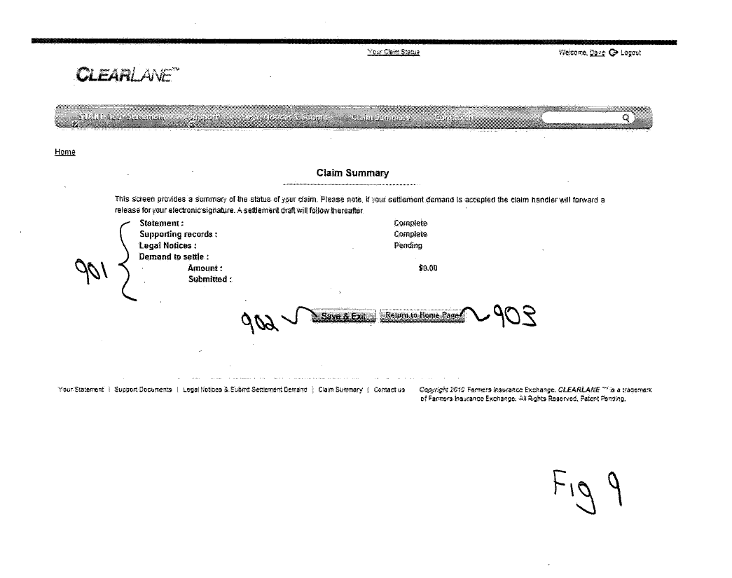

Following entering the details of the accident itself, the present system then proceeds to gather information about the injuries suffered by the claimant. Specifically, at 319, the operator is asked whether they were taken from the accident scene by ambulance. At 320, the operator is asked whether or not they feel pain or discomfort due to the accident. If they have pain or discomfort, they are then asked at 321 to select the region(s) of the body that have this pain or discomfort. Possible selections may from a dropdown menu may include: “cervical”, “thoracic”, lumbar” or “other”. In addition, the claimant is then asked at 322 whether they have undergone any medical treatment(s). FIG. 4 shows an example of a medical bill that is presented to the operator so that they will best understand what a medical bill submission should look like. Specifically, the medical bill will show the dates and nature of the treatments, the CPT code for the treatment and the charges incurred. The operator can download FIG. 4 as a PDF when viewing the screen of FIG. 3.

Returning to FIG. 3, if the operator has indicated that they did have medical treatment, they are then asked to input further details of that medical treatment for each of the various medical treatments that they received, and from each of the various medical providers who treated them. Specifically, at 323 the operator is prompted to push a button to “Add Provider Information”. When this option is selected, a pop-up screen appears as illustrated in FIG. 5. At this stage, the operator identifies the name of the medical provider at 501. Next, at 502, the operator inputs the contact information for the provider. At 503, the operator enters the number of visits that they made to this medical provider. At 504, the operator then selects the primary diagnosis made by the medical provider. For example, in the particular case of neck or back sprains and strains, the operator may select between diagnoses including options like: “sprain and strain of the neck”, “sprain and strain of the spine”, etc. or “unknown”. In addition, the operator is asked at 505 when the first visit to the medical provider occurred and at 506 when the last visit to the medical provider occurred. The operator then enters the total dollar amount billed by this particular provider at 507 and the total amount that the operator has paid to the provider at 508. Finally, at 509, the operator submits the information into the computer system. As can be expected, a claimant may use the services of several different medical providers. Each time the operator wants to add information on a new medical provider, (s)he selects “Add Provider Information” at 323 and is returned to a clean pop-up of FIG. 5 and is prompted to enter the same information for that new provider.

In optional embodiments, a Liability Evaluations proposal screen (not seen) can be added to FIG. 3. This screen will allow for the resolution of disputed liability claims through proposed liability determinations drawn from focus group opinions of similar accidents.

Returning to FIG. 3, the provider name, diagnosis, visits and dollar amounts billed are all displayed in chart form at 324. At 325, the operator is asked whether or not (s)he has had treatments for similar symptoms in the six months prior to the accident. At 326, the operator is asked whether or not (s)he has receive treatment at a military or Indian health facility.

Next, at 327, the operator is asked whether they have lost earnings as a result of the accident. If “yes” is selected at 327, then the operator is asked to “Add Employer Information” at 328. At this stage, the pop-up screen shown in FIG. 6 appears for adding employer information. Similar to FIG. 5, FIG. 6 permits the operator to name the employer at 601 and enter the employer's contact information at 602. Finally, at 603, the operator submits the information into the computer system.

Returning again to FIG. 3, the operator then is presented with an open text box at 329 to enter any further details of the injuries attributable to the accident. At 330, the operator is asked to enter the amount of the medical bills for which they are seeking reimbursement. The operator then inputs the estimated gross loss of earnings and other out of pocket expenses that the have incurred at 331. Finally, the operator is given the option to “Save and Proceed” at 332 or “Cancel” at 333. If the operator decides to Save and Proceed at 332, they then advance to the supporting information input screen shown in FIG. 7.

The screen shown in FIG. 7 guides the claimant in assembling the necessary supporting information to submit their claim. First, the claimant is reminded that a Vehicle Repair Estimate needs to be submitted. As explained at 701, the estimate may be uploaded through a link on the webpage itself, or faxed or mailed in to the person or corporate entity operating computer system 30. In optional aspects of the invention (not shown), the operators are also given the option of uploading photos taken by their own digital cameras. Next, at 702, the Medical Bills that are to be submitted can be uploaded through a link on the webpage itself, faxed or mailed in, or alternatively, these records can be obtained by the insurance carriers 40 by having operator 20 complete a “Medical Record Authorization” form provided by a claim handler at the insurance carrier 40.

Next, at 703, the “Loss Of Earnings And Other Out Of Pocket Expenses” can be uploaded through a link on the webpage itself, faxed or mailed in, or alternatively, these records can be obtained by the insurance carriers 40 by having operator 20 complete an “Employment Record Authorization” form provided by a claim handler at the insurance carrier 40. When the operator sends faxed documents to the person operating computerized injury evaluation system 33, that person receives and then uploads the documents into the computerized injury evaluation system 33.

Next, at 704, the operator confirms the amount they are seeking for reimbursement. Specifically, at 705, the amount that the operator has identified for loss of earnings and other out of pocket expense is presented. Finally, at 706, the displayed amount of proposed compensation for pain and suffering (as calculated by computerized injury evaluation system 33) is displayed for the operator to look at. Next to that, at 707, the total value of the proposed claim settlement (as calculated by computerized injury evaluation system 33) is also displayed for the operator to look at. Finally, the operator is given a choice. (S)he can select “Save And Proceed” by pressing 709, or “Cancell” by pressing 710.

Next, operator 20 is presented with the screen as illustrated in FIG. 8. This screen displays the necessary legal notices required for the submission of the insurance claim to an insurance carrier. These necessary legal notices will, of course, depend upon the jurisdiction in which the present system is used since different states have different laws. After repeating the medical bills at 801, the out of pocket expenses at 802, the lost earnings amount at 803 and the pain and suffering amount at 804, the legal notices are displayed. The operator is required to check each of the various boxes 805A, 805B, 805C, 805D, 805E, 805F, 805G, 805H, 805I, 805J and 805K after reading each of the associated legal notices. Possible general disclaimers may include disclaimers such as: (i) “the present system is not providing legal advice, and you may wish to discuss any questions you have regarding your claim with an attorney”; (ii) “attorneys identified by the present system do not work for the corporation or entity operating the system”; (iii) “the results obtained are for an average person of similar age without a pre-existing condition in a similar accident”; (iv) “accepting the system's proposed settlement will require a release of liability”; (v) “unpaid medical bills are your responsibility”; “the carrier is not bound to accept the proposed settlement (but instead retain ability to investigate and make counter offer)”; etc. Finally, the operator is given the option to “Submit” or, at 806, the option to “Discontinue Use” at 807.

Finally, if option “Save And Proceed” is selected, operator 20 is then presented with the screen as illustrated in FIG. 9. FIG. 9 displays a quick summary of the claim prior to its formal submission to the insurance carrier. This screen gives operator 20 one last chance to consider submitting their claim through system 30. Specifically, the operator is told at 901 when all the requirements of the “Statement” (FIG. 3), the “Supporting Records” (FIG. 7) and the “Legal Notices” (FIG. 8) are completed. At this stage, the operator is given the final option to “Save and Exit” their claim at 902 or to “Return To Home Page” at 903. In various optional embodiments of the invention, either the claimant or the selected insurance carrier may pay a submission fee.

What is claimed is:

1. A computer network for generating a proposed insurance claim settlement and submitting the proposed insurance claim settlement to an insurance carrier, comprising:
(a) a computer system that receives injury information from an operator through a web-based interface;
(b) a computer system that receives accident information from the operator through a web-based interface;
(c) a computerized injury evaluation system that receives injury information and the accident information and then computes:
(i) a proposed claim settlement amount based upon the injury information and the accident information, and
(ii) (ii) a likelihood of claim settlement for the proposed amount based upon the identity of a selected insurance carrier;
(d) a computer system that presents the proposed claim settlement amount and the likelihood of claim settlement statement to the operator through a web-based interface; and
(e) a computer system that sends a demand for the proposed claim settlement amount from the computerized injury evaluation system to the selected insurance carrier after receiving an approval from the operator.

2. The network of claim 1, wherein the computerized injury evaluation system comprises:
a computer sub-system that determines a proposed financial amount that corresponds to lost earnings;
a computer sub-system that determines a proposed financial amount that corresponds to payment of medical bills; and
a computer sub-system that determines a proposed financial amount that corresponds to pain and suffering damages.

3. The network of claim 2, wherein the computerized injury evaluation system adds together the three financial amounts in claim 2 and presents the total as the proposed claim settlement.

4. The network of claim 1, wherein the person injured in the accident is the operator.

5. The network of claim 1, wherein the similarity of the accident to other accidents is determined by comparing the received accident information to accident information pre-stored in a database.

6. The network of claim 5, wherein the accident information pre-stored in the database is information corresponding to a plurality of different accidents that occurred in the local vicinity of the accident submitted by the operator.

7. The network of claim 5, wherein the accident'information pre-stored in the database is information corresponding to data compiled by focus groups in the local vicinity of the accident submitted by the operator.

8. The network of claim 1, further comprising:
(f) a computer system that sends either:
(i) a check and a release; or
(ii) a counter offer,
from the selected insurance carrier to the operator after the selected insurance carrier has reviewed the proposed insurance claim settlement, and after receiving an approval from the selected insurance carrier.

9. The network of claim 1, wherein the computer system that sends the proposed claim settlement from the computerized injury evaluation system to the selected insurance carrier permits the operator to first select the applicable insurance carrier among a plurality of insurance carriers using a web-based interface.

10. The network of claim 1, wherein the likelihood of settlement statement comprises a statement of the percentage of time that the selected insurance carrier has accepted a proposed claim settlement generated by the computer network in the past.

11. The network of claim 1, wherein the computer network simultaneously receives insurance coverage and accident information from a plurality of different operators and computes individual proposed claim settlements and likelihood of claim settlement statements for each of the plurality of different operators.

12. The network of claim 11, wherein the computerized injury evaluation system comprises:
a module for receiving the insurance injury information;
a module for receiving the accident information;
a database for storing both accident information and injury information from a plurality of different accidents; and
an analytical system module that compares the received accident and injury information to accident and insurance information in the database to determine the proposed claim settlement amount.

13. The network of claim 12, wherein the computer injury evaluation system further comprises:
A validation system that flags at least one of:
(i) medical expenses, or
(ii) lost earnings
received from the operator when the information is outside of pre-determined range boundaries.

14. The network of claim 1, wherein the computer system that receives accident information from the operator comprises a system for the operator to submit claim proofs to the selected insurance carrier.

15. The network of claim 14, wherein the claim proofs are at least one of medical bills and wage statements.

16. The network of claim 11, wherein each of the plurality of operators are located at different remote locations, each of the plurality of different insurance carriers are located at different remote locations, and the computerized injury evaluation system is located at a single central location.

17. A method for generating a proposed insurance claim settlement and submitting the proposed insurance claim settlement to an insurance carrier, comprising:
(a) a remote operator sending injury information through a web-based interface to a central computerized injury evaluation system;
(b) the remote operator sending accident information through a web-based interface to the central computerized injury evaluation system;
(c) the remote operator selecting an insurance carrier through the web-based interface;
(d) the central computerized injury evaluation system computing:
(i) a proposed claim settlement amount based upon the insurance injury information and the accident information, and
(ii) a likelihood of claim settlement based upon the identity of the selected insurance carrier;
(e) the central computerized injury evaluation system presenting the proposed claim settlement amount and the likelihood of claim settlement to the operator; and
(f) the remote operator authorizing the central computerized injury evaluation system to submit the proposed claim settlement amount to the selected insurance carrier.

18. The method of claim 17, wherein the central computerized injury evaluation system:
(i) records a financial amount that corresponds to lost earnings;
(ii) records a financial amount that corresponds to payment of medical bills; and
(iii) determines a proposed financial amount that corresponds to pain and suffering damages.

19. The method of claim 18, wherein the proposed financial amount that corresponds to pain and suffering damages is determined as a financial range.

20. The method of claim 18, wherein the central computerized injury evaluation system adds together the three financial amounts in claim 18 and presents the total as the proposed claim settlement amount.

21. The method of claim 17, wherein the central computerized injury evaluation system computes the proposed pain and suffering amount by comparing:
(i) the age of the person injured in the accident to the ages of persons injured in other accidents; and
(ii) the similarity of the impact of the accident to other accidents.

22. The method of claim 21, wherein the central computerized injury evaluation system compares the similarity of the accident to other accidents by comparing the received accident information to accident information pre-stored in a database corresponding to a plurality of different accidents that occurred in the local vicinity of the accident submitted by the operator.

23. The method of claim 22, further comprising:
focus groups in the local vicinity of the operator submitting the accident information that is pre-stored in the database.

24. The method of claim 17, further comprising:
(g) the selected insurance carrier reviewing the proposed insurance claim settlement amount submitted by the remote operator; and
(h) the selected insurance carrier instructing the central computerized injury evaluation system to send the remote operator either:
(i) a check and a release; or
(ii) a counter offer.

25. The method of claim 17, wherein the computer network simultaneously receives insurance coverage and accident information from a plurality of different operators and computes individual proposed claim settlements and likelihood of claim settlement statements for each of the plurality of different operators.
